(19) United States
(12) Patent Application Publication
(10) Pub. No.: US 2008/0210622 A1
(43) Pub. Date: Sep. 4, 2008

(54) Method for Assembling a Water Filter Cartridge to a Water Dispensing Appliance

(75) Inventors: A. Sohn Rachel, Evansville, IN (US); Joseph Mitchell Alan, Evansville, IN (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, Benton Harbor, MI (US)

(21) Appl. No.: 12/101,180

(22) Filed: Apr. 11, 2008

Related U.S. Application Data
(62) Division of application No. 11/062,386, filed on Feb. 22, 2005.

(51) Int. Cl. B01D 35/02; B23P 11/00

(52) U.S. Cl. 210/435; 29/428

(57) ABSTRACT

A method for assembling a water filter cartridge to a water dispensing appliance.

### CROSS-REFERENCE TO RELATED APPLICATION(S)

This application is a divisional of U.S. patent application Ser. No. 11/062,386, filed Feb. 22, 2005, which is incorporated herein by reference in its entirety.

### BACKGROUND OF THE INVENTION

The present invention relates to water filters and devices for use in purging filters of air before us.

The prior art provides various devices for use in filtering water. For example, water filters are used in water dispenser associated with refrigeration devices, wherein a user can obtain a glass of water from a dispenser located in a door of a refrigerator, without opening the door of the refrigerator. The water filter provided removes impurities from the water supply before the water is dispensed to the user. Since the removed impurities collect in the water filter, provisions are made for removing the water filter from the refrigeration appliance and replacing it with a fresh filter.

Typically the filters, when replaced, are exchanged for a fresh filter that is not yet filled with water, but rather is filled with air. This requires that the filter be purged of the air before being used, otherwise the filter may not operate correctly, and may cause the valves in the water dispenser to operate incorrectly, such as by dripping, after the dispensing operation has been completed. In some water filter applications, the body of the filter is arranged horizontally or at a non-vertical angle, due to space considerations, which, combined with the low pressure involved in the water supply in the refrigeration dispenser, require a significant amount of water, such as 2 to 3 gallons (32 to 48 eight oz. glasses of water), and a significant amount of time, such as 6 or 7 minutes, longer, to completely purge a filter of air when it is first attached to the dispensing system. Because of the horizontal or angled arrangement of the filter, air may become trapped in the filter, thus increasing the amount of water dispensing necessary to effect complete purging of the air from the filter.

In some water filters, a loose carbon material is used as the filter medium, and in such cases, when the filter is first purged of air, some loose carbon particles are dispensed, resulting in a grayish color in the water. In those instances, the user has a visual indication of when the filter is completely purged, that is when the gray color disappears from the water. However, in other filters, utilizing a solid core or fiber filter material, there is no discoloration of the water, and the user has no indication of when the filter has been purged of air. Typically water is dispensed from the dispenser long before all of the air is purged, giving the user a false indication that the purging process is complete. Thus, user may terminate the purging process after only filling 3 or 4 glasses of water, far less than necessary 2 to 3 gallons necessary to assure complete purging of the air from the filter. This has led to many instances of consumer complaints regarding dripping of the dispenser after a dispensing operation is completed. Because water appears to be properly flowing from the dispenser when operated, even service personnel cannot determine that the problem actually lies with an incompletely purged filter, and unnecessary repairs and parts replacements are made that could be resolved by merely completing the air purging process.

Thus, it would be an improvement in the art if there were provide an arrangement for purging air from a filter in a more rapid and complete manner, easily used by a user of the water dispensing apparatus.

### SUMMARY OF THE INVENTION

The invention relates to a method of assembling a water filter cartridge to a water dispensing appliance, comprising flushing the water filter cartridge by passing water from a water supply separate from the water dispensing appliance through the water filter cartridge, and upon the completion of the flushing step, fluidly coupling the water filter cartridge to the water dispensing appliance.

### BRIEF DESCRIPTION OF THE DRAWINGS

FIG. 1 is an exploded side elevational view of a filter and a filter flushing adapter system embodying the principles of the present invention.

FIG. 2 is an assembled side elevational view of the filter and a filter flushing adapter system of FIG. 1.

FIG. 3 is a side elevational view of the filter flushing adapter of FIG. 1.

FIG. 4 is an end elevational view of the filter flushing adapter of FIG. 3.

FIG. 5 is a side sectional view of the filter flushing adapter taken generally along the line V-V of FIG. 4.

FIG. 6 is a side perspective view of a known type of filter cartridge with which the present invention can be used.

FIG. 7 is side sectional view of an embodiment of the present invention in conjunction with the filter cartridge of FIG. 6.

FIG. 8 is a side elevational view of a second known type of filter cartridge with which the present invention can be used.

FIG. 9 is a side sectional view of an embodiment of the present invention in conjunction with the filter cartridge of FIG. 8.

### DETAILED DESCRIPTION OF THE PREFERRED EMBODIMENT

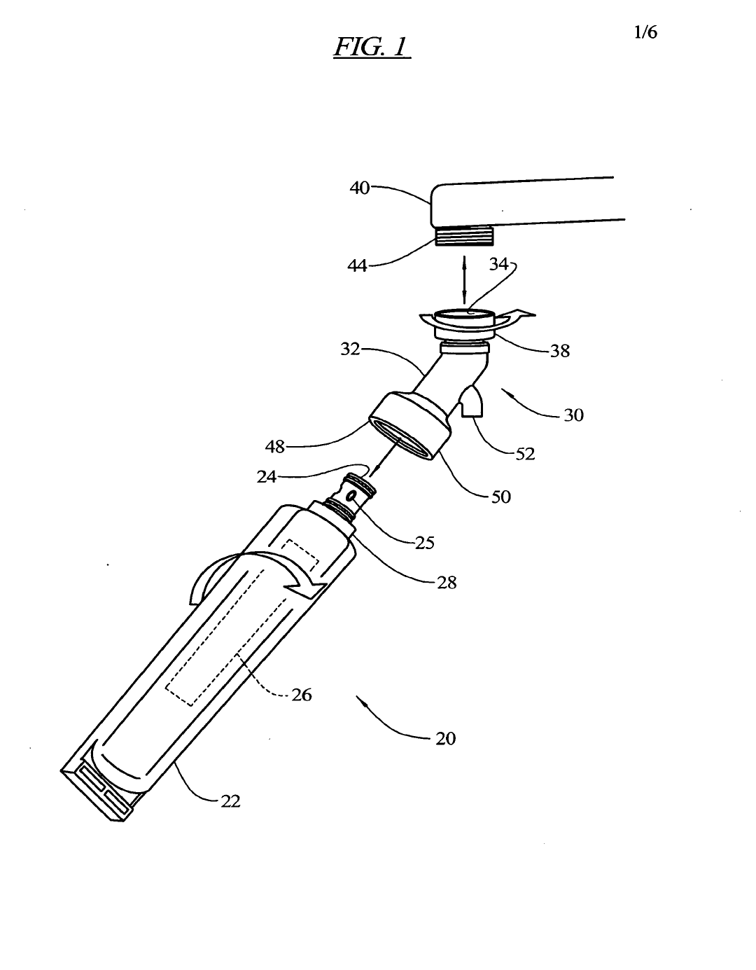

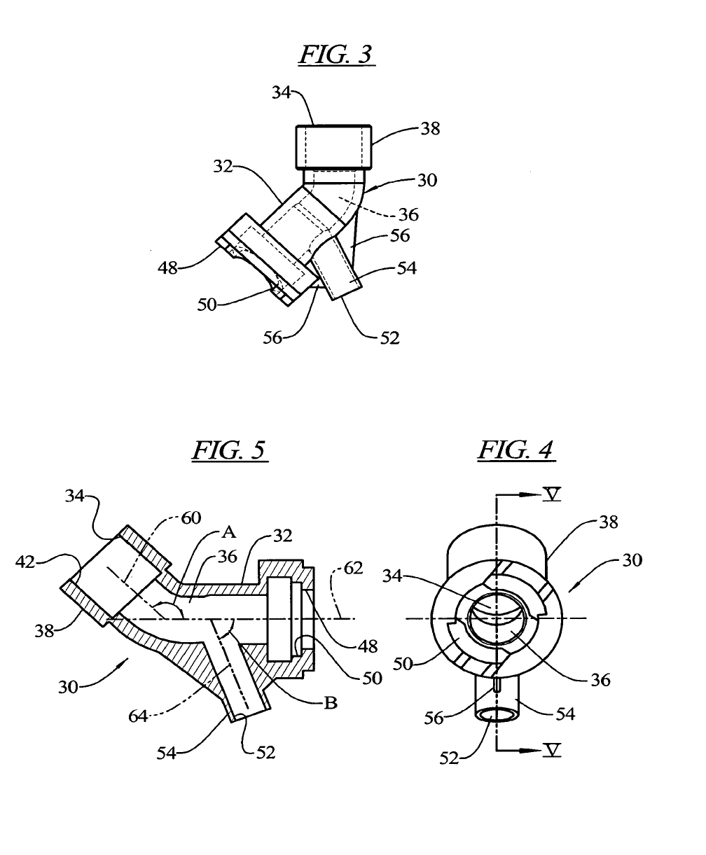

As illustrated in FIGS. 1-5, the present invention provides an adapter and a system for purging air from a filter device.

Shown in FIG. 1 is a filter and a filter flushing adapter system 20 including a filter device 22 having an axially oriented opening 24 comprising an inlet and a radially oriented opening 25 comprising an outlet 25, with a filter medium 26 positioned between the inlet and outlet. A bayonet connection arrangement may be provided, as is known in the art, such as screw threads. However, the bayonet connection arrangement 28 allows for the filter device 22 to be quickly and securely assembled with a water dispensing appliance with a relatively small rotation of the filter device, such as less than 45 degrees. Another type of connection could be a clamping arrangement where the filter is clamped to the water dispensing appliance without any rotation.

A filter flushing adapter 30 embodying the principles of the present invention includes a tube or body 32 having a first open end 34 leading to an interior passage 36 of the body. The first open end 34 may be provided with a connection fitting 38 configured to securely receive a kitchen faucet 40. For example, the connection fitting 38 may be provided with internal threads 42 configured to sealingly mate with external threads 44 on the faucet 40. Other types of connections between the faucet 40 and the filter flushing adapter 30 may be provided, or connection adapters may be used if the faucet is not provided with external threads as shown. Alternatively, the filter flushing adapter 30 may merely be held against or close to the faucet 40 so that water is directed into the first open end 34 to conduct the purging operation as described below, without a sealed or secure connection existing between the faucet and the adapter. The connection directly to the faucet 40 prevents any spray of water or misdirected overflow as the filter flushing adapter 30 is being used to fill the filter device 22.

A second open end 48 of the filter flushing adapter 30 also leads to the interior passage 36. In an embodiment, the second open end 48 may have a connection fitting 50 configured to receive the filter device 22. For example, if the filter device 22 has the bayonet connection 28, the connection fitting 50 on the adapter 30 may also be a complementary bayonet connection to provide for a secure connection between the filter device and the adapter. Other types of connection fittings, including friction fits between the adapter body 32 and the filter device 22 may be employed. Alternatively, the filter device 22 may merely be held against or close to the adapter body 32 during the purging process. Again, use of a connection fitting 50 between the filter flushing adapter 30 and the filter device 22, while not necessary to effect a purging of the air from the filter device, prevents spraying and misdirected leakage or overflow as the filter flushing adapter is being used to fill the filter device.

An overflow outlet 52 is positioned between the first open end 34 and the second open end 48, communication between the interior passage 36 of the body 32 and an exterior of the body. The overflow outlet 52 may be provided in the form of a short tube 54 supportingly attached to the adapter body 32 by gussets or webs 56 to strengthen the adapter body and to prevent damage to the outlet tube in the even the adapter body is dropped or struck against a hard object.

In an embodiment, as best seen in FIG. 5, the adapter body 32 may be bent or angled such that an axis 60 of the first open end 34 is not coaxial with an axis 62 of the second open end 48. When the adapter body 32 is bent, the axis 60 of the first open end 34 may be displaced from the axis 62 of the second open end 48 by an angle A up to 90 degrees, and preferably the angle may be approximately 45 degrees. This will permit the filter device 22 to be positioned within a sink, with the open end 24 in an upper position, yet not requiring that the sink be deep enough to accommodate an entire length of the filter device. That is, with an angled connection provided by the adapter 30, a filter device 22 may be accommodated in a relatively shallow sink.

In an embodiment, the overflow outlet 52 may have an axis 64 which is not coaxial with the axis 60 of the first open end 34 or the axis 62 of the second open end 48. In such an arrangement, the axis 64 of the overflow outlet 52 may be displaced by an angle B up to 90 degrees from the axis 62 of the second open end 48 and preferably the angle may be approximately 70 degrees. The axis 64 of the overflow outlet 52 may be displaced by approximately 25 degrees from the axis 60 of the first open end 34. In this manner, the discharge from the overflow outlet 52 will be directed in substantially the same direction as the outlet from the faucet 40, namely, into the sink where the purging operation is occurring, and yet the water being directed through the adapter body 32 towards the second outlet 48 will not be immediately discharged through the overflow outlet 52. The overflow outlet 52 preferably communicates with the interior passage 36 downstream of the point where the flow changes direction between the first open end 34 and the second open end 48.

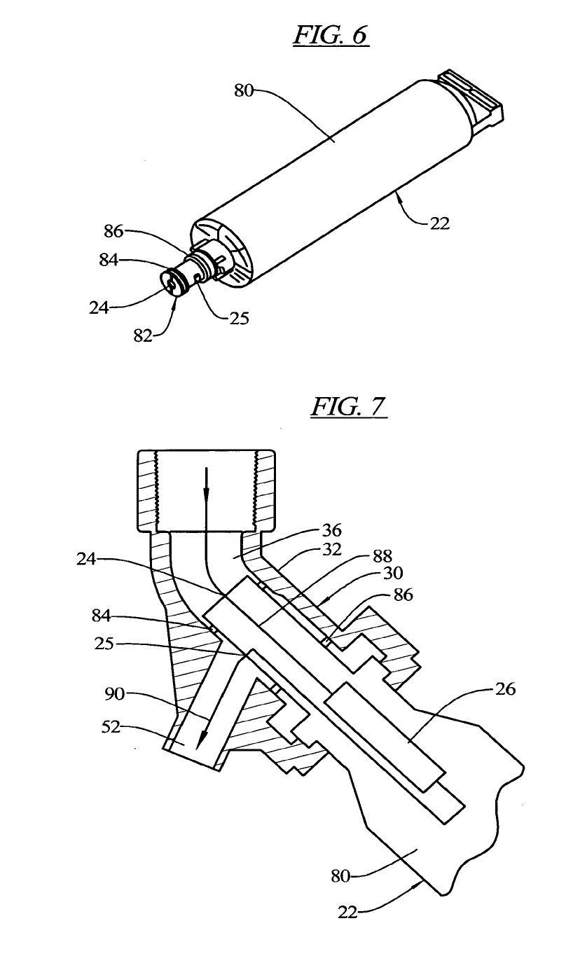

In an embodiment, the body 32 may be formed of a plastic material. One type of filter which can be used in conjunction with the present invention is illustrated in FIG. 6 where it is seen that the filter 22 includes a body 101 with a first end 102 that has the axially oriented inlet 24 leading to the interior of the filter body. Interior of the filter body 101 is a filter medium 26 (shown schematically in FIG. 7). The radially oriented outlet 25 is provided, also at the first end, but separated from the inlet 24. In use, water flows into the inlet 24, through the filter medium 26, and then out the outlet 25.

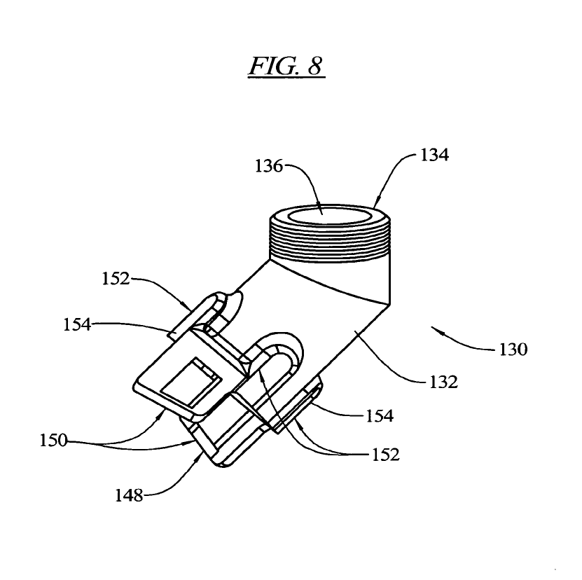

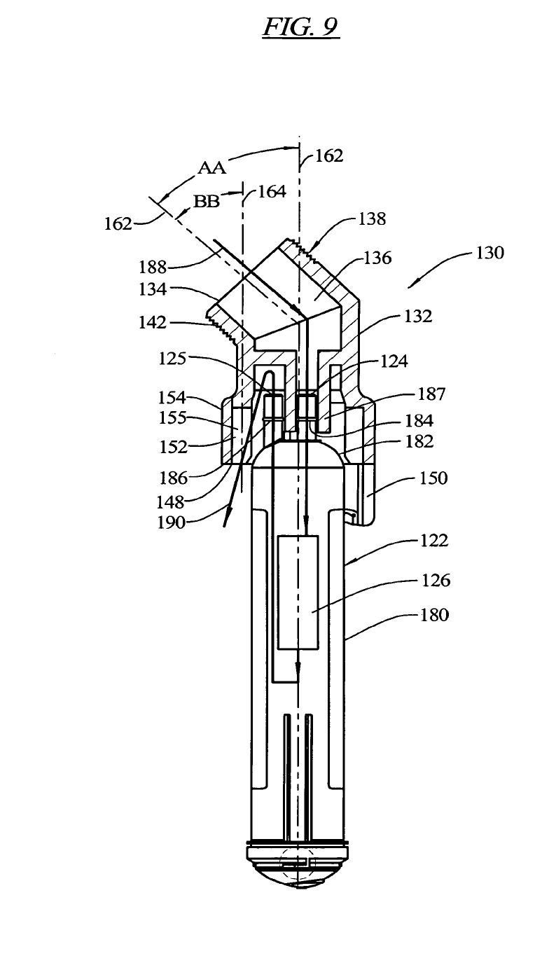

A second type of filter which can be used in conjunction with the present invention is illustrated in FIG. 8 where it is seen that the filter 22 includes a body 101 with a first end 102 that has the radially oriented inlet 24 leading to the interior of the filter body. Interior of the filter body 101 is a filter medium 26 (shown schematically in FIG. 9). The radially oriented outlet 25 is provided, also at the first end 102, but separated from the inlet 24. In use, water flows into the inlet 24, through the filter medium 26, and then out the outlet 25.

The filter adapter 30 of the present invention takes advantage of the physical arrangement of the filter body 101, and the locations and orientations of the inlets 24 and outlets 25.

As schematically illustrated in FIG. 7, with the first type of filter body 101, with an axially arranged inlet 24, the interior passage 36 forms a flow channel which directs water from the faucet directly into the inlet 24 so that the filter body will fill with water. The filter body 101 is already provided with sealing rings 108, 110, which also engage with walls of the interior passage 36 of the adapter 30 as shown in FIG. 7. This sealing arrangement assures that all of the water flowing into the adapter 30 from the faucet is directed into the inlet 24 along line 109. When the filter body 101 fills with water, first air, and then water will exit from the outlet 25 along line 107. In FIG. 7 it is seen that the filter outlet 25 is aligned with the overflow outlet 52 of the adapter 30, such that all water flowing out of the outlet 25 will pass through the overflow outlet, and will be directed into the sink, rather than spraying in undesired directions.

As schematically illustrated in FIG. 9, with the second type of filter body 101, with a radially arranged inlet 24, the interior passage 36 includes a flow channel 111 deviating from its straight flow path to allow the water from the faucet to flow into the radially oriented inlet 24 along line 109 so that the filter body 101 will fill with water. A sealing ring 112 on the end of the inlet 24 will mate with a surface 114 in the adapter body 32 to assure that the water flowing from the faucet will be directed only into the filter body 101. An overflow outlet 52, which also communicates with the interior passage 36 of the adapter 30 is aligned with filter outlet 25, and a sealing ring 116 on the end of the outlet 25 will mate with the surface 114 such that all water flowing out of the outlet 25 will pass through the overflow outlet 52, and will be directed into the sink, rather than spraying in undesired directions.

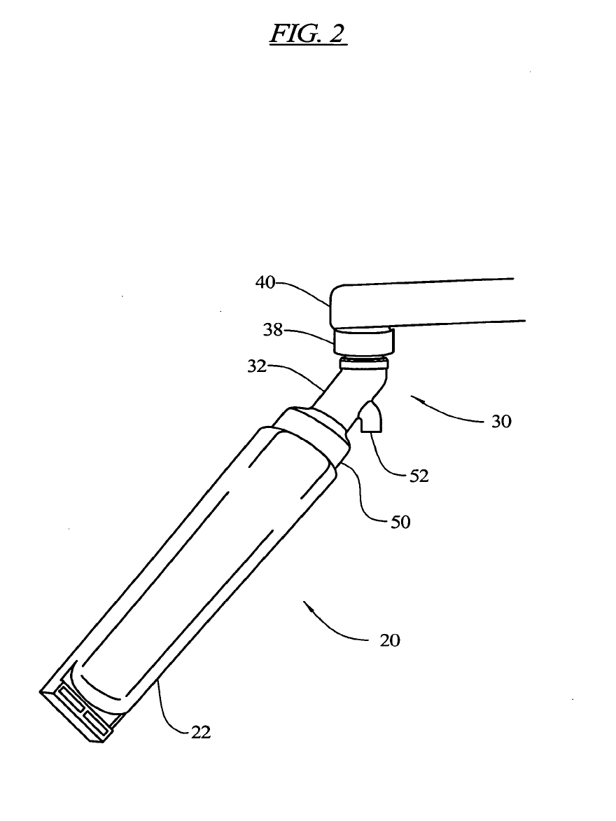

To operate the filter device and filter flushing adapter system 20, the filter flushing adapter 30 is first attached to the faucet 40, such as by rotating the adapter to threadingly engage the adapter with the faucet, as illustrated in FIG. 1. Once the adapter 30 is secured to the faucet 40, the filter device 22 may be attached to the adapter 32, such as by engaging the bayonet connections 28, 50. When the components of the system 20 are secured in this manner, as shown in FIG. 2, the faucet 40 may be turned on and water will flow through the adapter 30 into the inlet 24 of the filter device 22, filling the filter device with water and purging the air from the filter device. Since the filter device 22 is positioned in a substantially upright position, the water will fill the lower portions of the filter device, forcing the air in the filter to exit through the outlet 25 of the filter device, where the air will exit through the overflow outlet 52 of the adapter 30. As the filter device 22 fills with water, water will also be forced out of the overflow outlet 52, where it will be directed into the sink where the purging operation is occurring, thus requiring no additional effort on the part of the user.

Once the filter device 22 is completely purged of air, which usually will occur in less than one minute, the filter device may be removed from the adapter 30 and may be engaged with the water dispensing appliance. The adapter 30 may then be removed from the faucet 40 and stored until needed again when the next fresh filter device 22 is to be supplied to the water dispensing appliance. Alternatively, the adapter 30 may be disposed of at the end of the purging operation and a new adapter may be provided with the fresh filter device 22.

In another operation of the filter device and filter flushing adapter system 20, the adapter 30 is positioned between the faucet 40 and the filter device 22. The filter flushing adapter 30 may or may not be secured to either of the faucet 40 and the filter device 22 other than by hand. The faucet 40 is turned on and the water flows from the faucet through the adapter 30 and into the inlet 24 of the filter device 22. Air purged from the filter device 22 is permitted to exit through the outlet 25 of the filter device 22 and through the overflow outlet 52 of the adapter 30, as well as any water which may also be exiting from the adapter or filter device up to and upon a complete purging of the filter device. This water will be directed into the sink where the purging operation is occurring. Once the purging operation is complete, and the filter device 22 is completely filled with water and the air has been purged, the filter device may be removed from the area of the sink and may be engaged with the water dispensing appliance. The adapter 30 may also be removed from the area of the sink, either to be stored for later usage, or disposed of.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

What is claimed is:

1. A method of assembling a water filter cartridge to a water dispensing appliance, comprising:
flushing the water filter cartridge by passing water from a water supply separate from the water dispensing appliance through the water filter cartridge; and
upon the completion of the flushing step, fluidly coupling the water filter cartridge to the water dispensing appliance.

2. The method according to claim 1 wherein the flushing step comprises coupling the water filter cartridge to the water supply.

3. The method according to claim 2 wherein the coupling step comprises coupling the water filter cartridge to a household faucet.

4. The method according to claim 3 wherein the coupling of the water filter cartridge comprises connecting the water filter cartridge to the household faucet by an adapter having one end configured to mount to the household faucet and another end configured to mount to the water filter cartridge.

5. The method according to claim 4 wherein the adapter has an overflow outlet fluidly coupled to an outlet of the cartridge.

6. The method according to claim 1 wherein the flushing step removes air in the water filter cartridge.

7. The method according to claim 6 wherein the flushing step is completed upon removal of substantially all of the air from the water filter cartridge.

8. The method according to claim 6 wherein the water filter cartridge is maintained in a generally vertically orientation during the flushing step to aid in removal of air from the water filter cartridge.

9. The method according to claim 1 wherein the flushing step removes loose carbon material from the water filter cartridge.

10. A method of assembling a water filter cartridge to a water dispensing appliance, comprising removing air from the water filter cartridge prior to fluidly coupling the water filter cartridge to the water dispending appliance.

11. The method according to claim 10 further comprising coupling the water filter cartridge to a water dispensing appliance.

12. The method according to claim 10 wherein the removing the air step comprises passing water through the water filter cartridge.

13. The method according to claim 10 wherein the passing of the water step comprises coupling the water filter cartridge to the water supply.

14. The method according to claim 13 wherein the coupling step comprises coupling the water filter cartridge to a household faucet.

15. The method according to claim 14 wherein the coupling of the water filter cartridge comprises connecting the water filter cartridge to the household faucet by an adapter having one end configured to mount to the household faucet and another end configured to mount to the water filter cartridge.

16. The method according to claim 15 wherein the adapter has an overflow outlet fluidly connected to the end configured to mount to the household faucet and the end configured to mount to the water filter cartridge.

17. The method according to claim 10 wherein the removing the air step is completed upon removal of substantially all of the air from the water filter cartridge.

18. The method according to claim 17 wherein the water filter cartridge is maintained in a generally vertically orientation during the removal of air step to aid in removal of air from the water filter cartridge.
